(19) United States
(12) Patent Application Publication
(10) Pub. No.: US 2022/0191089 A1
(43) Pub. Date: Jun. 16, 2022

(54) ELECTRONIC DEVICE CONFIGURATION MECHANISM

(71) Applicants: ARM IP LIMITED, Cambridge (GB); ARM LIMITED, Cambridge (GB)

(72) Inventors: Mikko Johannes SAARNIVALA, Cambridge (GB); Szymon SASIN, Cambridge (GB); Yongbeom PAK, Cambridge (GB); Hannes TSCHOFENIG, Cambridge (GB)

(21) Appl. No.: 17/310,337

(22) PCT Filed: Jan. 9, 2020
(86) PCT No.: PCT/GB2020/050047

§ 371 Date: Jul. 28, 2021

(30) Foreign Application Priority Data
Feb. 1, 2019 (GB) 1901420.8

(51) Int. Cl. H04L 41/0806; H04W 4/70; H04L 41/085; H04L 9/40

(52) U.S. Cl. CPC H04L 41/0806; H04L 63/08; H04L 41/0856; H04W 4/70

(57) ABSTRACT

Broadly speaking, embodiments of the present technique provide methods, apparatuses and systems for operating a configuration server in communication with a client electronic device, comprising: receiving a handshake initiation message from the client electronic device specifying a registration at a specified server; receiving, from the client electronic device, a first enumeration of client features supported; responsive to detecting no stored client provisioning configuration for the client electronic device, retrieving, from the specified server, a second enumeration of server features supported; performing a comparison between the first and the second enumeration to detect a match between the client features supported and the server features supported; responsive to detecting a match, creating a client provisioning configuration; storing the client provisioning configuration in a configuration store; and sending a provisioning message comprising the client provisioning configuration to the client electronic device.

The present techniques generally relate to electronic device configuration on registration according to protocols for machine-to-machine communication, and particularly to the handling of configuration data during registration handshake processing.

There are ever increasing numbers of devices within the home, other buildings or the outdoor environment that have processing and communication capabilities which allow them to communicate with other entities (e.g. devices, servers, services etc.) within the same network or on a different network (e.g. on the internet) to access servers or services as part of the “Internet of Things”, whereby data is generally transmitted between devices and other entities using machine-to-machine (M2M) communication techniques.

For example, a temperature device in a home may gather sensed data and push the sensed data to a remote service (such as an application running in ‘the cloud’). The temperature device may then be controlled remotely by the remote service via received command data.

In other examples, a pollution monitoring device in a factory may comprise a sensor to gather information from various chemical sensors and arrange maintenance based on the gathered information; whilst a healthcare provider may use devices comprising sensors, such as a heart rate monitor to track the health of patients while they are at home.

The present applicant has recognised the need for improved electronic device configuration on registration according to protocols for machine-to-machine communication, and particularly to the handling of configuration data during registration handshake processing.

According to a first technique there is provided a machine-implemented method for operating a configuration server in communication with a client electronic device, comprising: receiving a handshake initiation message from the client electronic device specifying a registration at a specified server; receiving, from the client electronic device, a first enumeration of client features supported; responsive to detecting no stored client provisioning configuration for the client electronic device, retrieving, from the specified server, a second enumeration of server features supported; performing a comparison between the first and the second enumeration to detect a match between the client features supported and the server features supported; responsive to detecting a match, creating a client provisioning configuration; storing the client provisioning configuration in a configuration store; and sending a provisioning message comprising the client provisioning configuration to the client electronic device. Responsive to detecting a stored client provisioning configuration for the client electronic device, the method may retrieve the client provisioning configuration and send a provisioning message comprising the client provisioning configuration to the client electronic device. A second technique may provide corresponding interaction functions to client devices, and a third technique may provide corresponding interaction functions to servers.

In a hardware approach, there is provided electronic apparatus comprising logic elements operable to implement the methods of the present technology. In another approach, the computer-implemented method may be realised in the form of a computer program product, tangibly stored in a non-transitory storage medium, and operable in use to cause a computer system to perform the process of the present technology.

The techniques are diagrammatically illustrated, by way of example, in the accompanying drawings, in which:

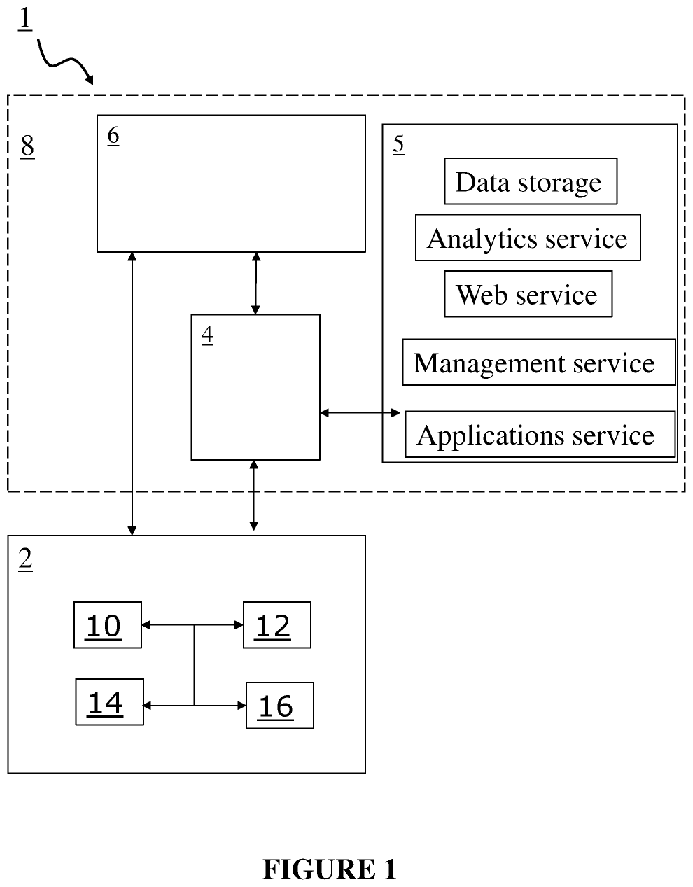

FIG. 1 shows an example deployment scenario 1 for a device 2 according to the present techniques.

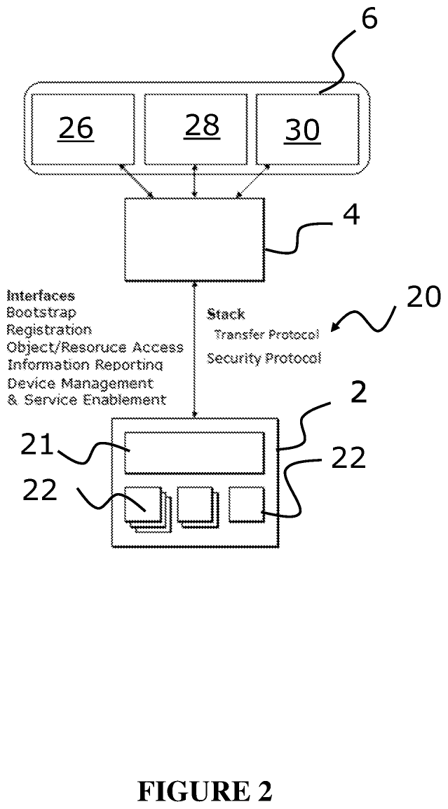

FIG. 2 shows an example architecture depicting a client-server relationship between the device of FIG. 1 and a server;

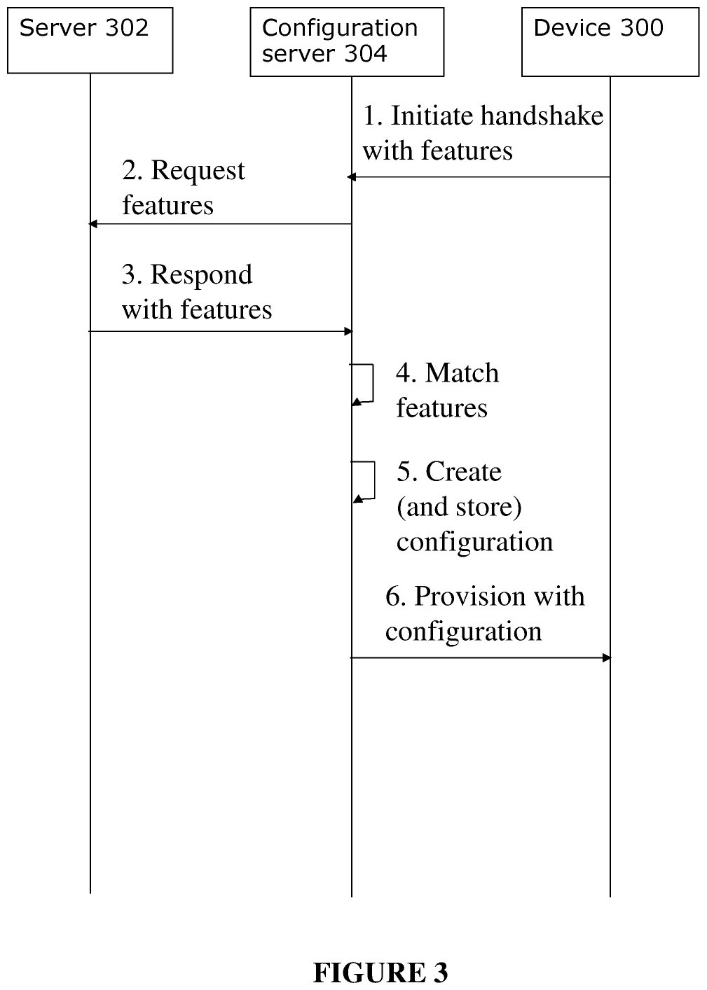

FIG. 3 shows a simplified representation of some of the communications between elements of a system according to an embodiment of the present technology; and

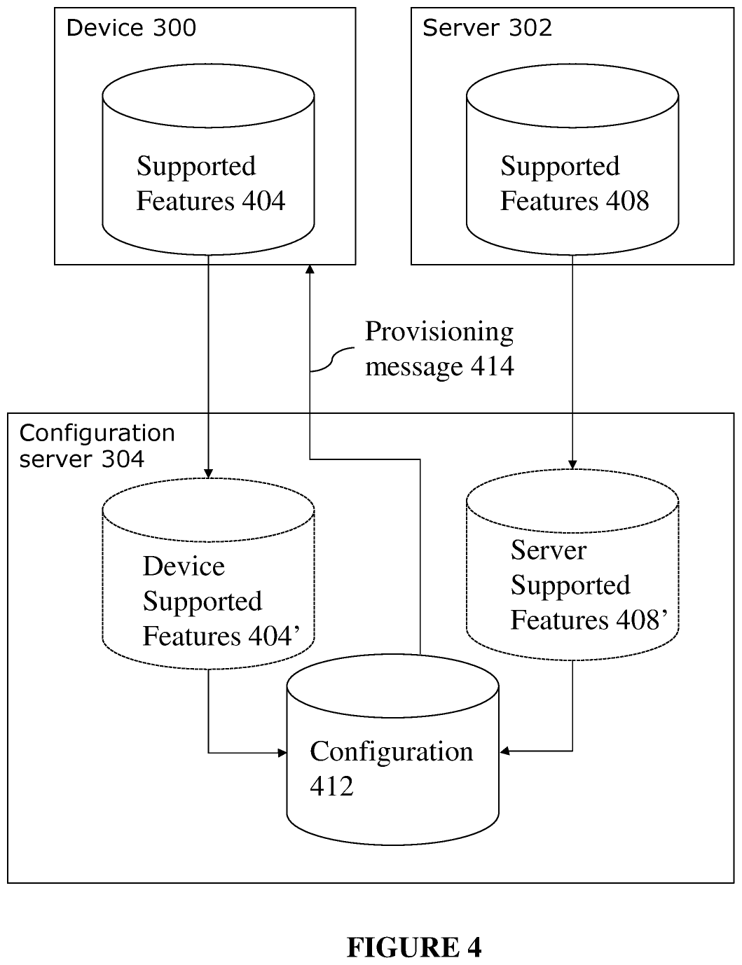

FIG. 4 shows an example of the types of storage elements that may form part of an implementation of the present technique.

Broadly speaking, embodiments of the present technique provide methods, apparatuses and systems to control electronic device registration according to protocols for machine-to-machine communication, and particularly to the handling of configuration data during registration handshake processing.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter.

Data exchange between programs and computers is a vital element. Different programs, computers and processors may exchange data without human intervention. Different networks and protocols are used in different environments. On the Internet, the Transmission Control Protocol/Internet Protocol (TCP/IP) is the basic protocol used in communication. TCP/IP takes care of assembling and disassembling the data to be transmitted in packets. IP handles the addressing so that packets are delivered to the correct destination. Above TCP/IP, the Hypertext Transfer Protocol (HTTP) is used as a client/server protocol. A program may send an HTTP request to a server which responds with another HTTP message.

FIG. 1 shows a deployment scenario 1 for a device 2 according to the present techniques.

Device 2 may be a computer terminal, a laptop, a tablet or mobile-phone, or may, for example, be a lightweight M2M (LwM2M) device running an LwM2M client. Device 2 can be used to turn objects into “smart-objects” such as streetlights, electric meters, temperature sensors and building automation, healthcare, and a range of other market segments as part of the IoT. It will be appreciated that the examples of market segments listed above are for illustrative purposes only and the claims are not limited in this respect. Device 2 is operable to communicate with one or more servers and/or services.

As described herein a server (depicted in FIG. 1 as “server 4” and “server 6”) may be a single computing device or software running on a computing device. However, the claims are not limited in this respect and the server may comprise a plurality of interconnected computing devices (or software running on a plurality of interconnected devices), whereby the plurality of interconnected computing devices may be distributed over one or more public and/or private networks.

In the present figures server 4 may, for example, be a LwM2M server, an application server, an edge server, a computer terminal, a laptop, a tablet or mobile-phone, or an application hosted on a computing device, and which provides deployment of one or more services (depicted in FIG. 1 as “service 5”). Such services may include one or more of: web service(s); data storage service; analytics service(s), management service(s) and application service(s), although this list is not exhaustive.

In the present figures server 6 comprises a bootstrap server which is operable as a configuration server to provision resources on the device 2 and to provide configuration data operable to configure the device 2. In embodiments, bootstrap server 5 may be any type of server or remote machine and may not necessarily be a dedicated bootstrap server. Generally speaking the bootstrap server 6 is any means suitable to perform a bootstrap process with the device 2 (e.g. machine, hardware, technology, server, software, etc.).

In the present examples, the server 4, bootstrap server 6 and/or services 5 may form part of a device management platform 8, such as the Pelion™ device management platform from Arm®, Cambridge, UK.

The device 2 comprises communication circuitry 10 for communicating with the one or more servers 4 and/or services 5.

The communication circuitry 10 may use wireless communication, such as communication such as, for example, one or more of: wireless local area network (Wi-Fi); short range communication such as radio frequency communication (RFID); near field communication (NFC); communications used in wireless technologies such as Bluetooth®, Bluetooth Low Energy (BLE); cellular communications such as 3G or 4G; and the communication circuitry 10 may also use wired communication such as a fibre optic or metal cable. The communication circuitry 10 could also use two or more different forms of communication, such as several of the examples given above in combination.

It will be appreciated that the device 2 could also use any suitable protocols for communications including one or more of: IPv6, IPv6 over Low Power Wireless Standard (6LoWPAN®), Constrained Application Protocol (CoAP), Message Queuing Telemetry Transport (MQTT), Representational state transfer (REST), HTTP, WebSocket, ZigBee®, and Thread®, although it will be appreciated that these are examples of suitable protocols.

As an illustrative example, CoAP defines the message header, request/response codes, message options and retransmission mechanisms, such as, for example, Representational State Transfer (RESTful) Application Programming Interfaces (APIs) on resource-constrained devices and supports the methods of GET, POST, PUT, DELETE, which can be mapped to methods of the HTTP protocol.

M2M communications are typically required to be secure to reduce the risk that malicious third parties gain access to the data, or to limit the access to data, by devices, servers or services. The device may use one or more security protocols to establish a communications path or channel for providing secure communications between entities. Exemplary security protocols may, for example, comprise Transport Layer Security (TLS) and Datagram Transport Layer Security (DTLS), whereby TLS/DTLS may be used to establish a secure channel between the device 2 and server 4 whereby TLS/DTLS include establishing communications using, certificates (e.g. X.509 certificates) and both pre-shared key and public key technology. The data (e.g. credential data) protected by TLS/DTLS may be encoded as plain text, binary TLV, JSON, CBOR, or any other suitable data exchange format.

The device 2 further comprises processing circuitry 12 for controlling various processing operations performed by the device 2.

The device 2 may further comprise input/output (I/O) circuitry 14, such that the device 2 can receive inputs (e.g. user inputs, sensor inputs, measurement inputs etc.) and or generate outputs (e.g. audio/visual/control commands etc.).

The device 2 further comprises storage circuitry 16 for storing resources, such as credential data, whereby the storage circuitry 16 may comprise volatile and/or non-volatile memory.

Such credential data may include one or more of: certificates, cryptographic keys (e.g. shared symmetric keys, public keys, private keys), identifiers (e.g. direct or indirect identifiers) whereby such credential data may be used by the device to authenticate (e.g. connect, establish secure communications, register, enrol etc.) with one or more remote entities (e.g. a bootstrap server/server/services).

FIG. 2a illustratively shows an example architecture 20 which illustrates a client-server relationship between the device 2 and server 4. FIG. 2b illustratively shows a schematic diagram of an object model on device 2.

Device 2 is hereafter referred to as “client device” but may also be referred to herein as a ‘device’, ‘node device’, ‘node’, ‘end-user device’ or ‘user device’. Device 2 typically belongs to a class of devices according to various of its hardware, firmware or software characteristics. For example, device 2 may belong to a “temperature monitoring” class of devices, all of which share some common characteristics; in another example, device 2 may belong to a class of devices produced by Manufacturer X, again sharing characteristics with others of its class. In a further example, device 2 may belong to a class defined by a level of firmware or software that is installed or installable thereon. At least parts of the configuration of the device 2 and provisioning with resources may be controlled by bootstrap server 6 according to device 2's class membership.

In the following examples the server 4 is depicted as a LwM2M server, such that the LwM2M server 4 and client device 2 communicate using protocols compliant with the Open Mobile Alliance (OMA) LWM2M specification.

The client device 2 comprises client 21 which may be integrated as a software library or built-in function of a module and which is used in communications with the LwM2M server 4. The client 21 may, for example, be an LwM2M client device.

Logical interfaces may be defined between the client 21 and LwM2M server 4, and three logical interfaces are depicted in FIG. 2, namely:
‘Client Registration’ interface may be used to perform and maintain registration with one or more servers and de-register from a server.
‘Device management and service enablement’ interface may be used by one or more servers to access object instances and resources available at the client device 2.
‘Information Reporting’ interface may be used to enable one or more servers to observe any changes in a resource on client device 2, and for receiving notifications when new values are available.

This list of logical interfaces is exemplary only and additional, or alternative, logical interfaces between the client 21 and LwM2M server 4 may be provided, for example, in accordance with various current or future versions of the OMA LwM2M specification.

The device 2 comprises various resources 22, which can be read, written, executed and/or accessed by the LwM2M server 4 or one or more further servers/services.

As an illustrative example, a resource is one which has a given value (e.g. generated by circuitry on the device). A web application may, via LwM2M server 4, request the value from the client device 2 (e.g. with a REPORT request), whereby the requested value is read and reported back to the web application by the LwM2M server 4.

As a further illustrative example, a resource comprising credential data may be provisioned at manufacture (e.g. during a factory provisioning process) or during a communication session with a bootstrap server, and subsequently used to register with the LwM2M server 4.

Resources 22 may be further logically organized into objects, whereby each device 2 can have any number of resources, each of which is part of an object. Objects and resources may comprise numerous instances, according to the requirements of the system and its applications.

A set of objects for device management purposes may include, for example:
A ‘security object’ to handle security aspects between the client device 2 and one or more servers;
A ‘server object’ to define data and functions related to a server;
An ‘access control object’ to define for each of one or more permitted servers the access rights the one or more servers have for each object on the client device 2;
A ‘device object’ to detail resources on the client device 2. As an example, the device object may detail device information such as manufacturer, model, power information, free memory and error information;
A ‘connectivity monitoring object’ to group together resources on the client device 2 that assist in monitoring the status of a network connection;
A ‘firmware update object’ enables management of firmware which is to be updated, whereby the object includes installing firmware, updating firmware, and performing actions after updating firmware;
A ‘location object’ to group those resources that provide information about the current location of the client device 2;
A ‘connection statistics object’ to group together resources on the client device 2 that hold statistical information about an existing network connection.

In embodiments device 2 may have one or more instances of an object. As an illustrative example, a temperature sensor device may comprise two or more temperature sensors, and the client device may comprise a different device object instance for each temperature sensor.

The objects/resources on a device may be remotely accessed/managed by, for example, software hosted on a server (e.g. a bootstrap server, LwM2M server 4) or an application running as part of a service 5.

In an embodiment client device 2 registers with a LwM2M server 4 by sending a registration request and providing various data, such as identifying all the resources thereon. The LwM2M server 4 stores the identified resources in the resource directory for the client device 2. Once the data is in the resource directory the data can then be looked up and resources accessed as required.

Whilst the server 4 above is generally depicted as a LwM2M server, the claims are not limited in this respect and in embodiments the server 4 may be an OMA Device Management (DM), a TR-069 server or a server which follows a standard/protocol set by the Open Connectivity Foundation or Open Interconnect Consortium.

Embodiments of the present techniques may provide implementations which conform to the Open Mobile Alliance Lightweight Machine to Machine Technical Specification, Version 1.0 and to one or more revision(s) thereof, including Version 1.3.

Typically, in systems such as that contemplated in the present disclosure, a client device registers with a server and engages in a handshake procedure that establishes the features that are supported by the parties. The term “features” is used to encompass operating characteristics of the client device and server, such as their processing capacity, as well as characteristics of installed support for aspects of networking, such as support for various types of cryptographic security, integrity and authentication. Information on any of these features may be exchanged as part of the handshake procedure by which communications are established between a client device and a server device. As will be clear to one of skill in the art, client devices and server devices in real-world contexts may have very different capabilities. Whereas, for example, a server may have a large amount of storage available for storing different cryptographic algorithms, and considerable processing power for cryptographic key calculations, a client device may be limited in size, power availability and processor power. Also, in a real-world context, client devices and servers may have installed differing versions of firmware and software with differing levels of support for features. In such contexts, it is a matter of importance that some agreement can be reached between client devices and servers as to what feature support each can make available.

The handshake procedure between client devices and servers may therefore be rather complex, and any mismatches, delays or errors in communication may have serious consequences for the effective operation of the system.

There is thus provided a machine-implemented method for operating a configuration server in communication with a client electronic device. The configuration server, which may be a bootstrap server, receives a handshake initiation message from the client electronic device specifying a registration at a specified server. The configuration server then receives, from the client electronic device, a first enumeration of client features supported. If the configuration server detects that it has no stored client provisioning configuration for the client electronic device, it retrieves, from the specified server, a second enumeration of server features supported. It then performs a comparison between the first and the second enumeration to see if it can detect a match between the client features supported and the server features supported. If it does detect a match, it creates a client provisioning configuration and stores it in a configuration store, which may be, for example, a database. Storing the configuration means that subsequent registrations can be accomplished by the configuration server without needing to repeat the request/response exchange with the specified server. The configuration server then sends a provisioning message comprising the client provisioning configuration to the client electronic device.

In FIG. 3 is shown a simplified representation of some of the communication flows among device 300, server 302 and configuration server 304. Device 300, which may be an LwM2M client device, initiates a handshake procedure 1 with the aim of making a connection with server 302. The handshake procedure 1 invokes the assistance of configuration server 304 (which may be a bootstrap server). It will be clear to one of ordinary skill in the art that there may in fact be multiple flows back and forth during the handshake procedure 1, but they have been consolidated in the drawing for ease of explanation. One flow of handshake procedure 1 from device 300 may carry information concerning the features that are supported by device 300, and may be accompanied by requests to server 302 to establish by agreement which features are to be used in subsequent communications between device 300 and server 302.

As described briefly above, the term “features” is used to encompass operating characteristics of the client device 300 and server 302, such as their processing capacity, as well as characteristics of installed support for aspects of networking, such as support for various types of cryptographic security, integrity and authentication. Information on any of these features may be exchanged as part of the handshake procedure by which communications are established between a client device and a server device.

Typically, an important group of the features in question are those involved in the security and integrity of the subsequent communications between client device 300 and server 302. For example, it is important for client device 300 and server 302 to establish which types of cryptography algorithms are supported, so that subsequent communications can be effectively secured.

As shown in FIG. 3, configuration server 304, acting on behalf of device 300, aims to supply the appropriate client provisioning configuration. The client provisioning configuration establishes for the client device 300 what feature support is agreed to be available at the server 302, thus enabling client device 300 to be configured appropriately for subsequent communications with server 302. If configuration server 304 already has a stored client provisioning configuration, it can retrieve it from storage and proceed immediately to 6 to send a provisioning message to device 300.

If configuration server 304 does not already have a stored client provisioning configuration, it sends a request 2 to server 302 to pass information about the features supported by device 300 and to request corresponding feature support from server 302. At 3, server 302 responds according to its supported features, for example, by enumerating features supported, or by responding directly to a request for feature support sent by device 300 at 1. At 4, configuration server 304 receives and analyses the response sent by server 302 at 3, in particular seeking to establish a match between the features supported by server 302 and those supported by device 300. Once a match has been established, configuration server 304 creates a corresponding client provisioning configuration at 5. The client provisioning configuration may also be stored at 5 for subsequent reuse. At 6, configuration server 304 sends a provisioning message with the client provisioning configuration to device 300.

In implementations, the present technology may be applied in various use cases, including advanced communications and security mechanisms, such as shared key support, zero round trip time resumption (0-RTT) with replay protection, and perfect forward security. These mechanisms will be well-understood by those of skill in the art and need no further description here.

In a first example use case, device 300 sends at 1 an enumeration of the key share signature algorithms it supports, and at 3, the server 302 sends to configuration server 304 an enumeration of the key share signature algorithms it supports. Examples of key share signature algorithms may include various version of the Secure Hash Algorithm (sha256, sha384, sha512) and group signatures, for example, using the X25519 (Curve25519) cryptographic function. It will be clear to one of skill in the art that these are merely examples, and that other cryptographic techniques may equally be used to implement key sharing.

In a second example use case, device 300 sends at 1 an indication that it supports zero round trip time resumption (0-RTT), and at 3, the server 302 sends to configuration server 304 an indication of support for zero round trip time resumption (0-RTT). In a third example use case, device 300 sends at 1 an enumeration of the replay protection features it supports, and at 3, the server 302 sends to configuration server 304 an enumeration of the replay protection features it supports. In this case, the addition of replay protection alleviates a potential exposure in 0-RTT. In a fourth example use case, device 300 sends at 1 an enumeration of the perfect forward security features it supports, and at 3, the server 302 sends to configuration server 304 an enumeration of the perfect forward security features it supports. In a fifth example use case, device 300 sends at 1 an indication of the post-handshake authentication features it supports, and at 3, the server 302 sends to configuration server 304 an indication of the post-handshake authentication features it supports, possibly including certificate type, such as X509, PGP or raw public key, for example. Using mechanism this makes it possible to defer elements of the authentication process until some time after the handshake procedure. For example, the handshake procedure may use server-authentication if the client device 300 indicates support for post-handshake authentication, and the system can then later make use of a post-handshake exchange to authenticate the client; in one alternative form of this scenario, the system may not make use of the post-handshake exchange mechanism for authentication via the transport layer, but may instead use application layer authentication. In another example, the main exchange may include mutual authentication using a client-side certificate followed by post-handshake authentication using attestation credentials.

Using embodiments of the present technology thus enables clients and servers to reach agreement concerning supported features, especially features relating to security and integrity of subsequent communications, with the potential for fewer flows back and forth during the early stages of establishing communications, and thus fewer opportunities for communications failures and the like to interfere with the proper functioning of the system. In particular, in an LwM2M TLS/DTLS (Transport Layer Security/Datagram Transport Layer Security) context, advanced feature support may be agreed between client device 300 and server 302 using the present technology to reduce the requirement for retries, additional exchanges of data, and cryptographic recalculations. In the case of, for example, an attempt to establish an agreement on key share support between client device 300 and server 302, there is an opportunity for the client to learn about the server's feature support up-front, so that the client can provide the server with the information it needs to establish the agreement. This reduces the number of messages required to establish key sharing, by eliminating at least one HelloRetryRequest and at least one additional ClientHello exchange. In this use case, the present technology offers an opportunity to reduce communications overhead and to reduce the number of cryptographic calculations required because the correct key share can be calculated immediately.

Turning now to FIG. 4, there is shown an arrangement according to the present technology, in which device 300 and server 302 are communicatively connected to configuration server 304. Device 300 comprises storage, which may be any type of data storage (including, for example, database storage), in which is held an enumeration of supported features 404, which may be hardware, firmware or software features. Server 302 likewise comprises storage, which may be any type of data storage (including, for example, database storage), in which is held an enumeration of supported features 408, which may be hardware, firmware or software features.

Configuration server 304 is operable to receive information indicating device supported features, which it stores, at least temporarily, in device supported features storage 404′. The information in supported features storage 404′ corresponds to the supported features 404 stored at device 300. Configuration server 304 is further operable to receive information indicating server supported features, which it stores, at least temporarily, in server supported features storage 408′. The information in supported features storage 408′ corresponds to the supported features 408 stored at server 302. As described above, configuration server 304 is operable to seek matches between device supported features storage 404′ and server supported features storage 408′, and thereby to create a client provisioning configuration for device 300. Configuration server 304 stores the client provisioning configuration in configuration storage 412, and is, as described above, operable to send a provisioning message 414 corresponding to the client provisioning configuration to device 300.

Embodiments of the present techniques also provide a non-transitory data carrier carrying code which, when implemented on a processor, causes the processor to carry out the methods described herein.

The techniques further provide processor control code to implement the above-described methods, for example on a general-purpose computer system or on a digital signal processor (DSP). The techniques also provide a carrier carrying processor control code to, when running, implement any of the above methods, in particular on a non-transitory data carrier or on a non-transitory computer-readable medium such as a disk, microprocessor, CD- or DVD-ROM, programmed memory such as read-only memory (firmware), or on a data carrier such as an optical or electrical signal carrier. The code may be provided on a (non-transitory) carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

Computer program code for carrying out operations for the above-described techniques may be written in any combination of one or more programming languages, including object-oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, the functional data comprising functional computer data structures to, when loaded into a computer system or network and operated upon thereby, enable the computer system to perform all the steps of the above-described method.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A machine-implemented method for operating a configuration server in communication with a client electronic device, comprising:
receiving a handshake initiation message from said client electronic device specifying a registration at a specified server;
receiving, from the client electronic device, a first enumeration of client features supported;
responsive to detecting no stored client provisioning configuration for said client electronic device, retrieving, from the specified server, a second enumeration of server features supported;
performing a comparison between said first and said second enumeration to detect a match between said client features supported and said server features supported;
responsive to detecting said match, creating a client provisioning configuration;
storing said client provisioning configuration in a configuration store; and,
sending a provisioning message comprising said client provisioning configuration to said client electronic device.

2. The machine-implemented method of claim 1, further comprising:
responsive to detecting a stored said client provisioning configuration for said client electronic device, retrieving said client provisioning configuration; and,
sending a provisioning message comprising said client provisioning configuration to said client electronic device.

3. The machine implemented method of claim 1, said receiving, from the client electronic device, a first enumeration of client features supported comprising receiving an enumeration of shared key signature algorithms supported.

4. The machine implemented method of claim 1, said retrieving, from the specified server, said second enumeration of server features supported comprising retrieving an enumeration of shared key signature algorithms supported.

5. The machine implemented method of claim 1, said receiving, from the client electronic device, said first enumeration of client features supported comprising receiving an enumeration of zero round trip time resumption (0-RTT) features supported.

6. The machine implemented method of claim 1, said retrieving, from the specified server, said second enumeration of server features supported comprising retrieving an enumeration of zero round trip time resumption (0-RTT) features supported.

7. The machine implemented method of claim 1, said receiving, from the client electronic device, said first enumeration of client features supported comprising receiving an enumeration of replay protection features supported.

8. The machine implemented method of claim 1, said retrieving, from the specified server, said second enumeration of server features supported comprising retrieving an enumeration of replay protection features supported.

9. The machine implemented method of claim 1, said receiving, from the client electronic device, said first enumeration of client features supported comprising receiving an enumeration of perfect forward security features supported.

10. The machine implemented method of claim 1, said retrieving, from the specified server, said second enumeration of server features supported comprising retrieving an enumeration of perfect forward security features supported.

11. The machine implemented method of claim 1, said receiving, from the client electronic device, said first enumeration of client features supported comprising receiving an indication of post-handshake authentication features supported.

12. The machine implemented method of claim 1, said retrieving, from the specified server, said second enumeration of server features supported comprising retrieving an indication of post-handshake authentication features supported.

13. The machine implemented method of claim 1, said client electronic device comprising an LwM2M client.

14. The machine implemented method of claim 1, said specified server comprising an LwM2M server.

15. The machine implemented method of claim 1, said configuration server comprising an LwM2M server.

16. (canceled)

17. The machine implemented method of claim 1, said configuration store comprising a database.

18. A machine-implemented method for operating a client electronic device in communication with a configuration server, comprising:
sending a handshake initiation message from said client electronic device to said configuration server specifying a registration at a specified server;
sending, from the client electronic device to said configuration server, a first enumeration of client features supported for detecting a match between said features and server features supported by said specified server and creating a client provisioning configuration;
receiving, from said configuration server, said client provisioning configuration; and,
configuring said client electronic device in accordance with said client provisioning configuration.

19. A machine-implemented method for operating a server in communication with a configuration server, comprising:
receiving a request message from said configuration server indicating receipt of a handshake initiation message from a client electronic device specifying a registration at said server;
creating an enumeration enumerating features supported by said server; and,
sending a message comprising said enumeration to said configuration server to enable said configuration server to detect a match between client features of said client electronic device and server features supported by said server and create a client provisioning configuration.

20. A computer program comprising computer readable code to, when loaded into a computer and executed thereon, cause the computer to perform the method according to claim 1.

21. (canceled)

22. A non-transitory data carrier carrying code which, when implemented on a processor, causes the processor to carry out the method according to claim 1.
